(19) United States
(12) Patent Application Publication
(10) Pub. No.: US 2026/0273818 A1
(43) Pub. Date: Sep. 17, 2026

(54) Multi-layer metal hybrid transaction card and process for manufacture

(71) Applicant: COMPOSECURE, LLC, Somerset, NJ (US)

(72) Inventor: Rom Koubi, Somerset, NJ (US)

(73) Assignee: COMPOSECURE, LLC, Somerset, NJ (US)

(21) Appl. No.: 19/563,610

(22) Filed: Mar. 11, 2026

Related U.S. Application Data
(60) Provisional application No. 63/770,482, filed on Mar. 12, 2025.

(51) Int. Cl. B29C 45/16; B29C 45/14; B32B 3/26; B32B 15/08; B29K 705/12; B29L 9/00

(52) U.S. Cl. CPC B29C 45/1679; B29C 45/14; B29C 45/1671; B32B 3/266; B32B 15/08; B29K 2705/12; B29L 2009/003; B32B 2250/05; B32B 2311/30; B32B 2425/00

(57) ABSTRACT

A process for making a smart card includes placing a substrate layer and at least one graphics layer in a mold, and introducing a flowable plastic material into the mold, wherein the flowable plastic material cures to form a molded plastic material that bonds with and overlays the at least one graphics layer and connects the at least one graphics layer to the substrate layer. Smart cards, blank smart cards, or smart card intermediates made thereby feature a molded plastic material bonded to the at least one graphics layer with a first portion extending over the outer-facing surface of the at least one graphics layer, a second portion extending between the inner-facing surface at least one graphics layer and one of the opposite surfaces of the metal layer, and one or more interconnecting portions extending into a hole, discontinuity, and/or perforations in the substrate layer.

### CROSS-REFERENCE TO RELATED APPLICATION

This application claims priority from U.S. Provisional Application Ser. No. 63/770,482, titled MULTI-LAYER METAL HYBRID TRANSACTION CARD AND PROCESS FOR MANUFACTURE, filed Mar. 12, 2025, incorporated in its entirety hereto by reference.

### BACKGROUND OF THE INVENTION

Plastic overmolding is a manufacturing process in which a secondary layer of plastic is molded over a pre-existing component (often called the substrate). This process typically uses injection molding, where the substrate is placed in a mold and then a different plastic material is injected over it. The result is a single, integrated part that combines the properties of both materials.

Plastic in-mold labeling (IML) is a manufacturing process where a pre-printed or pre-formed label is placed into a mold before the injection molding process begins. When the molten or otherwise flowable plastic is injected into the mold, it bonds with the label, and later cures to a molded plastic material that integrates the label into the final product. This method produces a durable, high-quality decorated item with the label becoming an inherent part of the product, rather than just a surface application. Exemplary processes are generally described in U.S. Pat. No. 6,773,653, titled IN-MOLD LABELING METHOD and U.S. Pat No. 6,053,414, titled DATA CARRIER CARD, incorporated herein by reference.

A trim die is a precision-engineered tool used in manufacturing processes—such as injection molding or stamping—to remove excess. A trim die is used to remove unwanted material -- often referred to as flash -- from a finished part. Its primary function is to cut away unwanted edges or surplus material, ensuring that the final product has clean, consistent, and defined contours. The use of a trim die not only enhances the aesthetic appeal of the product but also improves its overall functionality and quality.

A blanking die is a precision-engineered tool used in manufacturing to cut or punch out a specific shape, known as a blank, from a larger sheet or strip of material. In the blanking process, the die shears the desired portion from the workpiece, ensuring that the removed blank meets the required dimensions and quality standards. This blank typically serves as the final part or as an intermediate component for further processing, making the accuracy and efficiency of the blanking die important in stamping and metal forming operations. A blank may originate from either a stamped product, as described above, or a configuration where the perimeter flash around the card has been removed, with the “leftover” central portion being the desired blank.

Insert stamping embedding is a manufacturing technique where a pre-formed insert is positioned within a stamping die before the metal or plastic is formed. During the stamping operation, the material is pressed or formed around the insert, thereby embedding it securely into the finished component. This process creates a unified part with the insert fully integrated, which can enhance the part’s mechanical strength, functionality, or aesthetic appeal while reducing the need for additional assembly steps.

Smart cards, such as payment cards, ID cards, and the like are well known in the art. As used herein, smart cards refers to cards embedded with circuitry, including integrated circuits, electronic chips, transponders, radio frequency identification (RFID) credentials, payment modules, and/or other electronic encoding, for communication with card readers for use as credit cards, bank cards, debit cards, smart cards, RFID cards, gift cards, loyalty cards, identification (ID) cards, membership cards, retail cards, check cards, transaction cards, or casino cards. Smart cards are typically capable of communicating electronically, via contact and/or contactless (e.g., via radio frequency (RF) or other near-frequency communications (NFC)) means. The chips that reside on smart cards may be encoded with additional security features and/or functionality, such as for identification, authentication, communication with mobile devices, providing signature operations, and the like. Exemplary cards may also have additional functional features such as display screens or biometric sensors (e.g., fingerprint sensors), or may have additional aesthetic features, such as jeweled inlays, precious metal layers or embedded features, and the like.

Cards capable of both contact and contactless communication are often referred to as dual interface (DI) cards. Dual interface function may be provided by integrated circuit (IC) chips configured to receive and transmit signals via both contact and contactless methods. Typically, the contacts are built into the chip. Some chips have module antennas built into the chip. Other chips connect to an external antenna. Some chips harness both internal and external antennas and may include an inductively or physical coupling between the module antenna and an external “booster” antenna. Booster antennas may be supplied as a separate layer of the card. Payment modules or other types of IC chips may also include inlays that comprise the IC chip mounted on a printed circuit board (PCB) containing the external antenna.

“Blank” smart cards refer to cards ready for encoding or personalization and are typically made a card manufacturer to the specification of a card issuer. After manufacture, the blank cards are encoded or personalized with details regarding an account and/or user associated with the card. The personalized card is then sent to an end user, also referred to as the card holder. As referred to herein “smart cards” or cards refer to any of the above, without limitation. Intermediate cards may refer to a blank card or any precursor of the finished card at any step in the manufacturing process.

Historically, smart cards were primarily constructed of plastic. However, in recent years, consumers have shown a preference for “metal” or luxury cards that include metal and/or other premium non-plastic materials (e.g., glass, ceramic, leather, wood, crystal, without limitation). Exemplary dual interface smart cards with metal layers are disclosed in U.S. Patent No. 10,534,990, titled METAL SMART CARD WITH DUAL INTERFACE CAPABILITY, owned by the common assignee of the present application and incorporated herein by reference in its entirety.

Hybrid metal cards include at least one metal layer and at least one non-metal layer, with the metal layer providing a desired degree of weight or heft to the card, and non-metal layers often comprising the outer layers that contain printing, holograms, magnetic stripes, QR codes, consumer name information, and graphics unique to the issuer (e.g. a bank or other financial services provider, a department store, a brand of gas) or to an affinity of the card holder (a university, a charitable cause, etc.) or even personalized bespoke designs selected by a card holder from a menu of choices or supplied by the card holder (e.g. a photo, drawing, or the like).

A payment module or other type of IC chip embedded in the card is configured to provide communication with a card reader, typically be both contact and contactless connections, as has now become commonplace. Such multi-layer metal hybrid transaction cards are typically manufactured by a lamination process. Improvements in processes for manufacturing hybrid cards more reliably and/or efficiently, by minimizing waste, employing fewer process steps and intermediate card movements or touches, and/or lowering costs have distinct advantages for commercial production and are in demand.

### SUMMARY OF THE INVENTION

Aspects of the invention relate to a process for making a smart card. In embodiments, the process includes the steps of (a) placing a substrate layer, which may be a metal layer, and at least one graphics layer in a mold, the substrate layer having opposite surfaces and a periphery; and (b) introducing a molten or otherwise flowable plastic material into the mold, wherein the flowable plastic material cures to forms a molded plastic material that bonds with and overlays the at least one graphics layer and connects the at least one graphics layer to the substrate layer. The substrate may further comprise a hole, which may be a through-hole, and, optionally, a discontinuity from the hole to the periphery. The hole may have a first set of dimensions, wherein a predetermined chip to be embedded in the card has a second set of dimensions smaller than the first set of dimensions, and the process further comprises disposing an insert into the hole, the insert dimensioned to bridge the second set of dimensions to the first set of dimensions. The substrate layer may have an adhesion promoting layer on one or both of the opposite surfaces of the substrate layer.

In embodiments, the substrate layer has a plurality of perforations extending between the opposite surfaces of the metal layer, and the flowable (e.g., molten) plastic material fills the perforations during step (b). The at least one graphics layer has an outer-facing surface and an inner-facing surface, and the plastic material may extend between the inner-facing surface and the substrate layer and over the outer-facing surface to define an outer surface of the transaction card. In embodiments in which the transaction card has a front graphics layer and a back graphics layer, the front graphics layer may be connected to a first surface of the substrate layer by a front portion of the molded plastic material and the back graphics layer may be connected to a second surface of the substrate layer by a back portion of the molded plastic material during the molding step.

The process may further include the step of (c) trimming away one or more portions of one or more of the substrate layer, the at least one graphics layer, and the plastic material to define a finished card blank intermediate having a desired periphery. In embodiments, the substrate layer has a plurality of tabs during performance of steps (a) and (b), each tab featuring a carrying hole, and step (c) includes trimming away the plurality of tabs.

The process may further comprise the steps of (d) forming a designated pocket aligned with the hole in the substrate layer, the designated pocket extending from a top surface of the at least one graphics layer, through a portion of the plastic layer, and within the hole; and (e) inserting an IC chip (e.g. payment module) into the designated pocket. In some embodiments, step (d) may be performed by a portion of the mold during step (b), wherein the portion of the mold has predetermined dimensions corresponding to the designated pocket and extends from the at least one graphics layer to a desired depth within the hole. In other embodiments, step (d) may be performed by a material removal step after at least step (b) has been completed.

The molding step may be performed on an in-mold labeling (IML) machine, wherein the at least one graphics layer is provided to the IML machine as a label. The label may be supplied to the machine on a roll. The label may comprise a plurality of layers, such as a transparent layer and at least one layer of printed graphics. The label may include an antenna layer and/or a magnetic strip.

Another aspect of the invention relates to a smart card, black smart card, or blank smart card intermediate comprising a product of any one of the foregoing processes.

Yet another aspect of the invention relates to smart card, blank smart card, or smart card intermediate comprising a substrate layer, which may be metal, having opposite surfaces and a periphery, at least one graphics layer having an outer-facing surface and an inner-facing surface; and a molded plastic material bonded to the at least one graphics layer. The molded plastic material has a first portion extending over the outer-facing surface of the at least one graphics layer, a second portion extending between the inner-facing surface at least one graphics layer and one of the opposite surfaces of the metal layer, and one or more third portions extending into the substrate layer.

Embodiments of the smart card, blank smart card, or smart card intermediate include embodiments in which the substrate has a hole, such as but not limited to a through-hole, and, optionally, a discontinuity from the hole to the periphery, and an integrated circuit (IC) chip mounted in a designated pocket extending from the at least one graphics layer, through the molded plastic layer, and within at least a portion of the hole in the substrate layer. The hole in the metal layer may have a first set of dimensions and the IC chip may have a second set of dimensions smaller than the first set of dimensions, wherein the card further comprises an insert disposed in the hole bridging the second set of dimensions to the first set of dimensions. In embodiments, the substrate layer further comprises a plurality of perforations extending between the opposite surfaces of the substrate layer, and the molded plastic material extends through the perforations.

The smart card, blank smart card, or smart card intermediate may have a front graphics layer and a back graphics layer, the front graphics layer bonded over a first surface of the substrate layer by the second portion of the molded plastic layer, the back graphics layer bonded over a second surface of the substrate layer by a third portion of the molded plastic material, the first portion of the molded plastic material defining a front surface of the card, and a fourth portion of the molded plastic material defining a back surface of the card. The molded plastic material may surround the front graphics layer, the back graphics layer, and the metal layer. In embodiments, each of the first portion and fourth portion of the molded plastic layer define a discrete layer unconnected to any other portion, and the second and third portions of the molded plastic material are connected to one another by the one or more interconnecting portions of the molded plastic material, wherein the one or more interconnecting portions extend through at least the through hole and optionally through the optional discontinuity. In embodiments in which the substrate layer comprises a plurality of perforations extending between opposite surfaces of the substrate layer, the one or more interconnecting portions of the molded plastic material further extend through the plurality of perforations. In embodiments, each of the first, third, and fourth portions of the molded plastic material each defines a discrete layer unconnected to any other portion of the molded plastic material. In other embodiments, the substrate layer extends to a periphery of the card in a plurality of substrate edge locations, and the molded plastic material interconnects the first, second, third, and fourth portions of the molded plastic material in regions of the card periphery disposed between the plurality of substrate edge locations. Embodiments may comprise one or more of an antenna layer or a magnetic strip. An adhesion promoting layer or bonds formed between an adhesion promoting layer, the substrate layer, and the molded plastic material may be present on one or both of the opposite surfaces of the substrate layer.

Still another aspect of the invention relates to a smart card, blank smart card, or smart card intermediate comprising a metal substrate layer having a top surface, a bottom surface, a periphery, a through-hole, and a discontinuity extending from the top surface to the bottom surface and from the through-hole to the periphery; a top graphics layer having an outer-facing surface and an inner-facing surface; a bottom graphics layer having an outer-facing surface and an inner-facing surface; and a molded plastic material bonded to the top graphics layer, the bottom graphics layer, and the metal substrate layer. The molded plastic material defines a first portion extending over the outer-facing surface of the top graphics layer, a second portion extending between the inner-facing surface of the top graphics layer the top surface of the metal layer, a third portion extending between the inner-facing surface of the bottom graphics layer and the bottom surface of the metal, and a fourth portion extending layer over the outer-facing surface of the bottom graphics layer. One or more interconnecting portions connecting the second portion to the third portion extends at least through the through-hole and the discontinuity. The metal substrate layer may further comprise a plurality of perforations, wherein the one or more interconnecting portions of the molded plastic material extend through the plurality of perforations to connect the second portion to the third portion.

### BRIEF DESCRIPTION OF THE DRAWINGS

FIG. 1A is an exploded top perspective view of an exemplary stack of layers for forming an exemplary card blank intermediate in accordance with an embodiment of the invention.

FIG. 1B is an exploded top perspective view of another exemplary stack of layers for forming an exemplary card blank intermediate in accordance with an embodiment of the invention.

FIG. 2A is a top perspective view of a first exemplary substrate layer of an exemplary card in accordance with an embodiment of the invention.

FIG. 2B is a top perspective view of a second exemplary substrate layer, having perforations, of an exemplary card in accordance with an embodiment of the invention.

FIG. 3 is a top perspective view of a third exemplary substrate layer, having a through-hole insert, of an exemplary card in accordance with an embodiment of the invention.

FIG. 4A is a bottom perspective view of an exemplary card blank intermediate, prior to a trimming step, in accordance with an embodiment of the invention.

FIG. 4B is a top perspective view of the exemplary card blank intermediate of FIG. 4A, prior to the trimming step.

FIG. 5 is a top perspective view of an exemplary card blank intermediate, after the trimming step and before an IC chip insertion step, in accordance with an embodiment of the invention.

FIG. 6A is a cross-sectional view taken across line 6A-6A in FIG. 4B.

FIG. 6B is a cross-sectional view taken across line 6B-6B in FIG. 4B and a corresponding cross-sectional view of a mold component for creating a tactile feature on the card.

FIG. 6C is a cross-sectional schematic view of an exemplary IC chip and a substrate.

FIG. 7 is a flowchart depicting an exemplary process for making an exemplary token as described herein.

FIG. 8 is a schematic top view diagram depicting an exemplary sheet formed via one of the processes described herein, configured for a plurality of cards or card intermediates to be separated therefrom.

### DETAILED DESCRIPTION OF THE INVENTION

Aspects of the invention provide a method for manufacturing smart cards, ID cards, transaction cards, and the like, utilizing overmolding, metal embedding and in-mold labeling (IML) techniques. By integrating metal substrate, plastic over-molding and labels, aspects of the invention deliver enhanced adhesion and strengthening solutions and reduce the total number of process steps required to form a card. This integrated approach simplifies the manufacturing process while delivery increased reliability and simplicity in manufacturing. Although described herein as a process for making a metal hybrid smart card, it should be understood that the process and cards constructed thereby are not limited to any particular function or materials of the finished card. Accordingly, the term “card” may be used herein to refer to any type of cards eligible to made by the processes as described. It should be understood, however, that specific constructions of the cards may have certain advantages, as expressly discussed herein. Although certain layers are discussed in detail, it should be understood that embodiments may have fewer or additional layers or portions thereof and other features not expressly discussed herein.

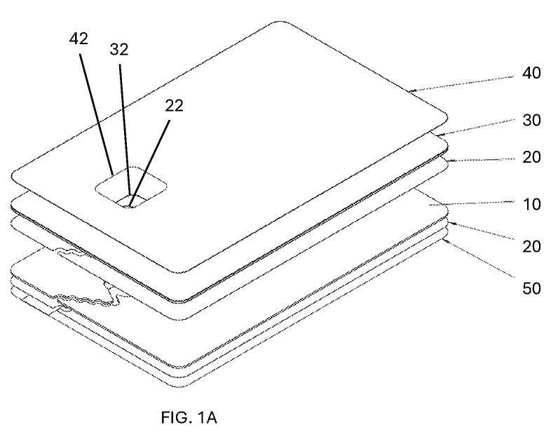

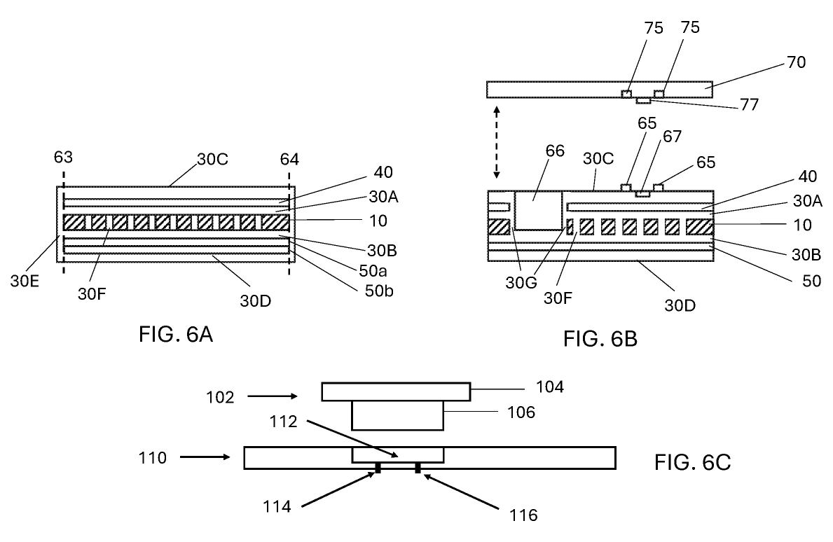

Referring now to FIGS. 1A and 1B and 7, an exemplary card may include a substrate layer 10 (e.g., metal, ceramic, glass, plastic, or some combination thereof), and at least one plastic molded layer 30, 30A, 30B. During the molding process, graphic layers 40, 50 (also sometimes referred to herein as labels or label layers) are inserted into the mold and are adhered to or otherwise bonded to the substrate layer during the molding process. Substrate layer 10 may optionally be coated or layered with an adhesion promoting layer 20, 20A, 20B on one or both sides, which may comprise an adhesive and/or another substance (i.e. an adhesive promoting additive, such as additives known in the art for adding to thermoplastic elastomers (TPE) and thermoplastic urethanes / thermal polyurethanes (TPU) for promoting adhesion between the specific types of materials – e.g., plastic, metal, ceramic, glass -- of a preferred construction, including epoxies, without limitation) to promote adhesion of the plastic molded material to the surface of the metal layer. Acrylic adhesive systems may also be used, as such systems provide strong metal–polymer bonding and offer good environmental stability, making them suitable for hybrid composite structures. As is known in the art, the adhesion promoting layer may comprise a coating on the substrate, or a double-sided adhesive film layer (e.g. polyester, such as polyethylene terephthalate glycol (PETG), coated with any adhesive formulation known in the art for promoting adhesion to the adjacent surfaces, including but not limited to epoxies and any of the adhesives described in US 6,773,653, without limitations, and including known pressure sensitive and/or heat sensitive adhesives that are activated by the pressure and/or heat of the mold to initiate bonding).

In embodiments, the adhesion promoting layer may comprise an organosilane coupling agent applied to one or both surfaces of the substrate layer, wherein the organosilane forms covalent bonds with oxide groups on the substrate surface and co-reacts with the polymer matrix of the molded plastic material to form a covalently bonded interface between the substrate and the molded plastic material. The organosilane coupling agent may be applied by wet methods, such as dip coating, spray coating, or wash priming, or by vapor deposition methods, such as plasma-enhanced chemical vapor deposition (PECVD), including atmospheric-pressure PECVD suitable for inline processing, using silane-containing precursors. The adhesion promoting layer may further comprise a combination of an organosilane coupling agent with one or more of the other adhesion promoting substances or adhesives described herein.

Embodiments include those in which one or more surfaces of the label, or portions thereof, comprise both an adhesive and an adhesion promoter, or only one or the other. As described further herein, the substrate layer may have other features to help promote integrity and bonding of the assembled layers. Physical adhesion promoting techniques may instead or also be used in addition to chemical adhesion promoters and/or over-molding processes. For example, plasma surface treatment may be used as an adhesion-enhancement method. Plasma treatment increases surface energy and promotes stronger chemical bonding between the metal and the polymer interface, whether using adhesives or over-molded plastic. Plasma treatment may be applied to inserts with through-holes as well as to solid metal blanks having no perforations.

At the completion of the molding step, the intermediate multi-layer card is removed from the molding tool and then subjected to further processing and/or finishing steps to produce the completed blank card. In preferred embodiments, substrate layer 10 comprises metal (e.g., stainless steel, tungsten, or the like), but the invention is not limited to any particular materials of construction.

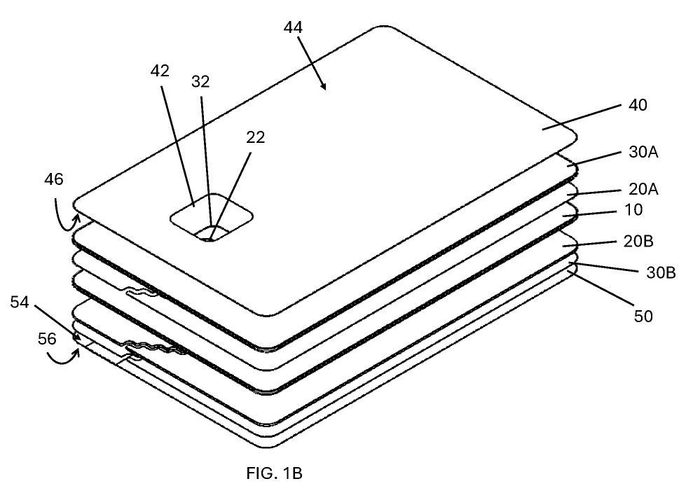

As depicted in FIG. 2A, substrate layer 10A comprises a through-hole 12 that extends between the opposite surfaces of the substrate layer for providing clearance for receiving the IC chip in a finished card. A discontinuity 14, also sometimes referred to as an eddy current slit or simply a slit or a slot, which terms may be used interchangeably, may extend from the through-hole to a periphery of the card, particularly in metal constructions. As depicted, the discontinuity has a curved, stepped, geometry and terminates on the short edge of the periphery of the card adjacent (but not horizontally aligned with) the through-hole 12 and relatively closer to the closest long edge of the card than a closest portion of the through hole to that long edge. The invention is not limited to embodiments having a discontinuity, or to any particular geometry of the discontinuity, however, but in embodiments, the discontinuity may conform to a geometry claimed or otherwise disclosed in U.S. Patent No. 10,762,412, titled DI CAPACITIVE EMBEDDED METAL CARD, owned by the common assignee of the present application and incorporated herein by reference in its entirety.

Substrate layer 10A may further include a plurality of carrier tabs 16 each with carrier holes 17, which are configured as connection points to the fixture during the molding process. The protrusion of these tabs from the periphery of the card permits the substrate to float in the molding tool and allows the injection material to flow from both sides of the substrate (i.e., in the gaps between adjacent tabs) in embodiments in which the molded plastic is intended to cover both sides of the substrate.

As depicted in FIG. 2B, substrate layer 10B may include all of the same features as described in connection with substrate layer 10A but may further include a plurality of perforations 11. Perforated substrate layer permits the injection molded material to penetrate the perforations during the molding process, thereby increasing the fixation between the substrate layer and the surrounding portions of the molded plastic material. Cards are typically subjected to peel testing and must meet a certain peel testing specification. Use of an adhesion promotion layer 20, 20A, 20B and/or the perforations increase the ability of the plastic over molded material to comply with peel testing requirements. In embodiments with perforations, and without an adhesive film layer disposed on the substrate, the molded plastic flows through the perforations between the two sides and creates a mechanical peel bond.

In some embodiments, including but not limited to embodiments in which the molded plastic material is desired on only one side (e.g., front or back) of the card such as is shown in FIGS. 1A-1B, adhesion promoting layers 20 may be provided on opposite sides of the substrate layer for enhancing peel test strength. In embodiments with adhesion promoting layers over the substrate layer, the adhesion promoting layer preferably has openings aligned with the discontinuity (where present) and the through-hole, as depicted in FIGS. 1A-1B. In some embodiments, such as wherein the adhesion promoting layer comprises an adhesive or a double-sided adhesive film, layer 20 forms a discrete layer that connects the plastic molded material to the substrate layer 10. In embodiments wherein the adhesion promoting layer comprises a compound intended to promote bonding of the plastic molded material to the substrate layer, the adhesion promoting layer may react with one or both of the substrate and the plastic molded material to form a bonding layer comprising bonds extending between the substrate and the plastic molded material. In embodiments without an adhesion promoting layer, the molded plastic material is in contact with the substrate layer.

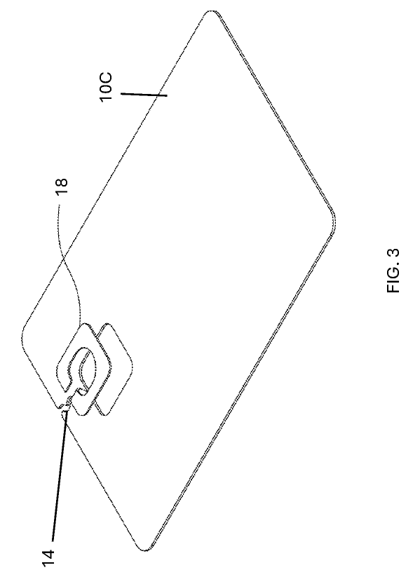

Regardless of whether the substrate has perforations 11, the plastic molded material 30 extends at least into and fills through-hole 12 and discontinuity 14 from a first surface of the card to at least the plane defined by the opposite surface of the card. In embodiments with perforations and molded plastic material on only one surface of the substrate, such as is depicted in FIG. 1A, the plastic molded layer 30 extends into and fills the perforations 11 and extends to the plane defined by the opposite surface of the substrate. In other embodiments, such as is depicted in FIG. 1B, with or without perforations in the substrate layer 10, the plastic molded material further extends from a first portion overlaying and connected to a first surface of the substrate layer to a second portion overlaying and connected to a second surface of the substrate layer. As shown in FIG. 1B, the molded material forms layers 30A and 30B that connect the label layers 40 and 50 to the substrate 10. The molded material also forms the outer layers 30C and 30D of the card intermediate (and in embodiments, ultimately, at least portions of the personalized card shipped to the card holder) as depicted in FIGS. 4A and 4B. The connection between layers 30A and 30B to the substrate 10 may be direct, such as in embodiments in which layers 20A and 20B are not present at all, or indirect, such as in embodiments in which layers 20A and 20B comprise adhesive layers, such as films with adhesive coatings or in embodiments in which layers 20A and 20B comprise adhesion promoting coatings that form a bonding layer between the molded plastic layer and the substrate comprising bonds among some or all of the materials of the molded plastic material, the adhesion promoting material, and the substrate layer.

Substrate 10A, 10B, or 10C may be formed by any technique known in the art, including but not limited to fine blanked, laser cut, powder compacted, or milled using a computer numerical control (CNC) machine into the shape as depicted in FIGS. 2A, 2B, or 3 and loaded into the molding tool. The substrate layer may be provided precoated with the adhesive or adhesion promoting layer 20, 20A, 20B on one or both surfaces. In embodiments with the discontinuity 14 and through-hole 12, these features are typically fine blanked or lasered into the substrate.

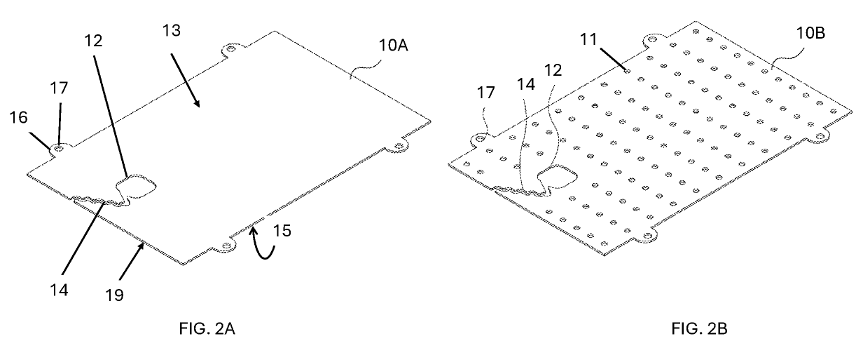

In embodiments, as depicted in FIG. 3, the substrate may include an additional embedded insert 18, which may be made of the same or a different material than the substrate (e.g., metal, plastic, ceramic, glass, without limitation). The connection between the substrate 10C and the embedded insert 18 may be, for example, force guided, thermal set, or weldment. The embedded insert allows for variance in the geometry (e.g., thickness, periphery) of chips and contact plates of the chips to be embedded in the card, without the need to change the substrate or other portions of the manufacturing process. Substrate 10C has notable differences from the features of substrates 10A or 10B as depicted in FIGS. 2A and 2B but may have some or all of the same features (e.g., carrier tabs/holes, perforations, slit / discontinuity geometry) that are the same or different from those shown in substrates 10A or 10BB.

In an exemplary manufacturing process, graphics layers 40, 50 are inserted into an injection molding (i.e., IML) tool, such as in a roll form or as individual “labels.” Although depicted as separate layers in the stacks illustrated in FIGS. 1A and 1B, in embodiments, label layers 40 and 50 may be connected to one another and folded over prior to the injection molding step, as depicted in the 6,053,414 patent and not separated, if at all, until the trimming step. In other embodiments, each label layer 40 and 50 may be supplied to the mold be separate rolls feeding on opposite sides of the substrate. The material of the labels, particularly a label that ultimately bonds with plastic molded material 30, comprises a plastic having technical characteristics that facilitate a thermal and/or mechanical bond between the plastic molded material 30 and the label 40. Exemplary materials for the label include polyethylene, polyvinyl chloride (PVC), polycarbonate, polystyrene, and combinations (e.g., co-extruded) thereof, without limitation. Exemplary materials for the molded plastic material include polypropylene, polyethylene, polycarbonate, acrylonitrile butadiene styrene (ABS), or other thermoplastic materials known in the art, without limitation, any of which may be glass fiber re-enforced. In particular, combinations of polycarbonate (PC) for the label and PVC or polypropylene (PP) for the molded plastic material may produce a particularly strong card with a highly durable label.

Preferably, labels 40, 50 each comprise transparent layers with printed graphics disposed on an inner-facing surface of the label 40, so that the transparent plastic provides the wear protection for the printed graphics. One of labels 40, 50 may include a magnetic strip 52 (such as is depicted on untrimmed blank 62 in FIG. 4A) or embedded antenna (not shown), such as a booster antenna. Labels 40, 50 may comprise a single layer of plastic with printed graphics or may comprise multiple layers that have been pre-assembled prior to feeding into the IML equipment. For example, the magnetic strip may be considered a layer. In embodiments in which an antenna is present, that antenna layer may comprise metal traces embedded in or printed or otherwise disposed on a non-metal material, wherein the non-metal material is opaque (to hide the traces from being visible from an outer surface of the card), with a transparent graphics layer, as described above, serving as an outer layer over the antenna layer, with the antenna layer disposed in the final card stack between the plastic molded layer and the graphics layer. The assembled layers may then form a single “label” 40 or 50 that is fed into the IML tool.

Substrate 10A, 10B, 10C is loaded into the molding tool utilizing the carrier holes 17 for positioning / floatation and the mold will close. At this point, flowable (e.g., molten) plastic molded material is added to the tool, such as by injection, casting, or low pressure flowing. The bonding of the molded material to the label(s) and to the substrate may be, for example, a chemical, thermoset or thermoplastic bond, or a combination of any of the foregoing. The flow of material may originate from one or more locations adjacent to the substrate, including but not limited to from locations adjacent any one or more of the edges, or from an area adjacent one or both of the substrate surfaces interior to the edges. The material may flow from one location of the substrate and flow through, adjacent, and/or around the substrate to cover all portions desired to be covered, or the flow of material may originate from both multiple locations (e.g., from locations adjacent both the top surface and bottom surface).

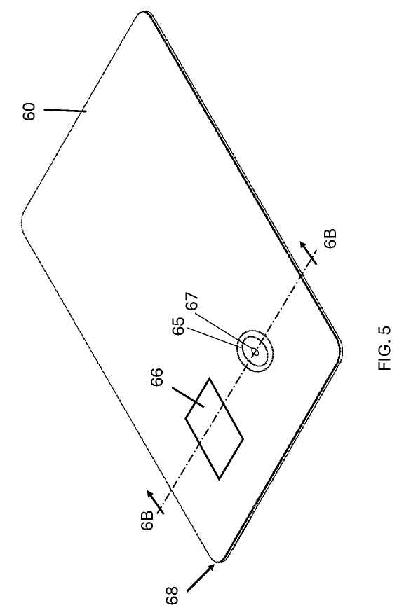

Following a setting period suitable for curing the flowable (especially when molten in flowable form) plastic sufficiently for handling of the card and for allowing the combination of material layers to equalize to room temperature or within a suitable temperature within range thereof, the multi-layer card intermediate 62 is then moved to a trimming process. Exemplary setting periods may include a first duration of setting time (e.g. 10 - 30 seconds) with the in-molded card disposed within the mold (e.g. with the mold closed), and a cooling period outside of the molding tool of (e.g. 10 to 30 minutes) to allow the assembled card bank to return to or approaching ambient temperature (e.g. 60-90 F). Such cooling before trimming may be particularly important for a card with a metal substrate layer or for other combinations of materials in the stack that have substantially different thermal expansion properties, so that the metal (or other thermally expansive outlier) layer returns to its normal room temperature dimensions before trimming from generally larger dimensions caused by thermal expansion during the molding process. In the trimming process, carrier tabs 16a-16d and any undesired flash 29 (e.g., along lines 63 and 64 of blank 62, as depicted in FIGS. 4B and 6A) are removed, such as by a cutting process, including but not limited to die trimming / blanking, water jet, laser cutting, or a CNC cutting process. Using a blanking / die trimming process at this stage to remove the flash allows the mechanical and thermal energy applied during stamping or die trimming to be absorbed outside the final card area. This results in improved surface quality and reduced deformation on the finished card, which is especially beneficial for hybrid metal–polymer constructions.

Thus, in accordance with process 700 depicted in FIG. 7, the substrate and labels are placed in the mold in step 702 (which may comprise discrete steps of placing the substrate and placing the label(s), which may occur in any sequence), and then the molding compound (e.g. plastic) is injected into the mold in step 706, thus encapsulating the substrate and labels. The molding material is then cured in step 708, typically by cooling (although this curing step may comprise other processes, as is described herein later). The curing, especially when it comprises a cooling step, may comprise some curing (i.e., setting) in mold, and additional curing outside the mold, as described above. The semi-finished blank is then trimmed (as described above) or otherwise shaped or finished (dimensionally) in step 710. In exemplary processes, the process further includes creating (e.g. by milling) a pocket to receive the IC chip in step 712, and then inserting the chip in the pocket in step 714, using processes well known in the art.

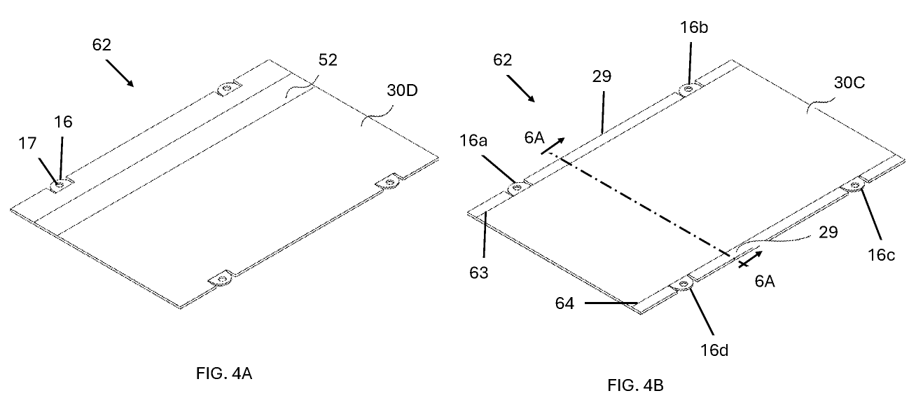

Although not depicted in FIG. 4B, the finishing step typically includes rounding the corners of the card to achieve a typical smart card geometry as depicted in blank 60 in FIG. 5 having rounded corners 68 having a suitable radius known in the art and defined by accepted standards. In embodiments, this trimming process cuts the card so that the edge of the substrate layer 10 is visible around the periphery of the card, particularly when it is metal, so that the card holder (and anyone who inspects the physical card) can see the metal. This results in a finished smart card and smart card blank intermediate in which the molded plastic material forms a discrete portion on the bottom surface of the card, with the portions disposed between the label / graphics layers and the substrate connected to one another at least via the through-hole, the discontinuity, and the plurality of perforations, and to the top layer the through-hole. However, in other embodiments, the periphery of the metal substrate may be smaller than the periphery of the finished card so that the metal substrate only extends to the edges of the card in select substrate edge locations (where the tabs 16a-d are cut off during finishing), with molded plastic material connecting the front and back portions of the card as well as the portions that extend between the graphics layers and the substrate between the substrate edge locations defined by the remnants of the tabs. Such constructions may provide a stronger peripheral bond by encapsulating more of the card within the interconnected portions of plastic molded material.

Once the card is formed to its final shape and dimensions, as depicted in FIG. 5, the card blank intermediate 60 will now proceed to the usual processes of inserting the IC chip (e.g. payment module), typically comprising securing the chip into the pocket using an adhesive, known in the art. Notably, FIGS. 1A–1B depicts an opening 42 in label 40 and opening 22 in optional adhesive promoting layer aligned with through-hole 12 (not visible in FIGS. 1A-1B) prior to assembly. In some processes, the fixture of the mold (not shown) may include a protrusion that penetrates openings 42 and 22 and extends a sufficient depth into through-hole 12 to form the designated pocket, including opening 32 in molded plastic material, during the injection molding process. The resulting card blank intermediate 60 from such a process may also include a corresponding molded pocket 66 when it leaves the molding equipment. The fixture protrusion may be adjustable in depth and/or size corresponding to the size of the opening in insert 18 (e.g., the fixture may be configured to receive interchangeable parts having different protrusion geometries corresponding to desired pocket sizes for receiving predetermined IC chips).

In other embodiments, openings 42, 22 may not be present in the stack of layers, and the fixture may not have a protrusion configured to form the designated pocket for receiving the IC chip during the molding process. In such processes, after creation of the blank, material is removed from the blank (i.e. by milling, laser removal, etching, etc.) through layer 40, material 30, and layer 20 (if present) and at least partially into through-hole 12 in substrate 10 to form a chip-receiving pocket for receiving the IC chip. Such milling steps are already well known as part of existing manufacturing processes. Likewise, process steps for inserting and bonding the chip in the pocket, and any other finishing processes, may be performed, as are well known in the art. Other finishing processes may include applying hot stamps (e.g., hologram and/or a signature-receiving strip) to the otherwise finished card surface. In processes in which the magnetic strip is not formed on label 50 prior to molding, it may be applied at this stage to an external surface of the card.

In embodiments, the designated pocket for receiving the chip may be configured so that the molded plastic material extends between the chip and the through-hole in the substrate. In such embodiments, the outer edges of the chip are separated from the edges of the substrate layer by an adhesive layer that is in contact with the molded plastic material that lines the through-hole. In other embodiments, the designated pocket may extend to the edges of the opening in the substrate such that the chip snugly fits in the opening (i.e., outer edges of the chip are separated from the edges of the substrate layer by only an adhesive layer). The desired size of the pocket relative to the substrate layer as described may be defined by material removal or by parts of the fixture during molding, as described herein.

Thus, the process steps discussed herein result in the creation of a smart card, blank smart card, or smart card intermediate 60 comprising a substrate layer 10, 10A, 10B, 10C. In preferred embodiments, the substrate comprises metal. The substrate (as depicted, for example, in FIG. 2A) has a top surface 13, a bottom surface 15, a periphery 19, a through-hole 12, and a discontinuity 14 extending from the top surface to the bottom surface and from the through-hole to the periphery. Top graphics layer or label 40 has an outer-facing surface 44 and an inner-facing surface 46. Bottom graphics layer or label 50 has an outer-facing surface 54 and an inner-facing surface 56. As depicted in FIGS. 1B, 6A, and 6B, molded plastic material 30 is bonded to the top graphics layer, the bottom graphics layer, and the metal substrate layer. The molded plastic material defines a first portion 30C extending over the outer-facing surface of the top graphics layer 40, a second portion 30A extending between the inner-facing surface of the top graphics layer the top surface of the metal layer, a third portion 30B extending between the inner-facing surface of the bottom graphics layer and the bottom surface of the metal layer, and a fourth portion30D extending over the outer-facing surface of the bottom graphics layer. One or more interconnecting portions 30E, 30F, 30G interconnect the second portion 30A to the third portion 30B extending at least through the through-hole 12 (as a lining 30G) and the discontinuity 14 (not shown). As depicted in FIGS. 6A and 6B, in embodiments in which metal substrate layer 10B has a plurality of perforations 11, the one or more interconnecting portions 30F of the molded plastic material 30 extend through the plurality of perforations 11 to connect the second portion 30A to the third portion 30B. Embodiments may have more or fewer overall layers.

In embodiments with a molded pocket, formed by a protruding member of the mold that is disposed within opening 42 in graphics layer 40 and at least partially within through-hole 12 in the substrate layer 10 during the molding process, the subsequent molded layers 30C, 30A, and 30B may all be connected to one another by interconnecting portion 30G that defines a lining of the molded pocket that separates the chip to be secured therein from contact with substrate 10 (which may be particularly important when substrate 10 comprises metal). In embodiments, the periphery of the chip may be separated from the periphery of the substrate by a non-conductive layer comprising molded plastic, an adhesive, or a combination thereof. In portions without such a protruding member of the mold, layer 30C (just like layer 30D) may not have any interconnections to any other portions of the molded plastic.

Embodiments of the invention may include cards with one or more layers or partial layers other than those described above and shown in the Figures. Referring to FIG. 1A, these one or more layers (not shown) may be formed on a surface of the substrate 10, on a surface of or above the graphics layer 40 and/or 50, or may be freestanding and interposed between the facing surfaces of the substrate 10 and the graphics layers, interposed between graphics layer 40 and/or 50 and the molded layer 30A, 30B, 30C, or 30D formed thereover, or a combination thereof. Such additional layers may have adhesive or adhesion promotion layers or coatings, or a combination thereof, as desired, and/or may be located between the adhesive or adhesion promoting layers 20A, 20B and the substrate. Completed cards and intermediates may therefore be defined by a stack of layers. These additional layers are not illustrated in connection with each embodiment, as one of skill in the art can readily understand from the description above how such layers fit into the illustrations already provided, including embodiments in which one or more of substrate 10 and graphics layers 40 and 50 comprise multiple layers or multi-ply components.

Exemplary layers, including but not limited to all or a portion of the graphics layer / label or substrate, may include one or more layers that define an “e-glass” layer. The e-glass layer typically comprises a base film, such as but not limited to polyethylene terephthalate (PET), coated with oxides, such as but not limited to SiO2, Al2O3 and others, suspended in a resin that is cured to form a fused polymer-oxide film. In embodiments, the e-glass layer may comprise a portion of the graphics layer. In other embodiments, all or a portion of the graphics layer / label or substrate, may comprise polymer-only substrates such as PET, PC, or PVC.

Another exemplary layer, including but not limited to all or a portion of the graphics layer / label or substrate, may comprise a curable epoxy (e.g., UV-curable epoxy) applied to the graphics layer or substrate, which may be applied in a manner that defines a pattern, such as applied using a mold.

Yet another exemplary layer, including but not limited to all or a portion of the graphics layer / label or substrate, may comprise a print layer, such an inkjet printed layer, screen printed layer, or plate-printed layer (e.g., printed by offset printing, flexography, or lithography). The print layer may comprise printed alphanumeric characters, symbols, graphics, patterns, and the like, without limitation. The printed substance may include colorants (e.g., dyes, pigments), inks, metals, fluorescent markers, or any type of applied substance that creates a desired effect.

Still another exemplary layer, including but not limited to all or a portion of the graphics layer / label or substrate, may comprise a metalized layer. The metalized layer may be formed by any process known in the art, including but not limited to a deposition method, such as physical vapor deposition (PVD) or another vacuum deposition method, to metalize the substrate. The metallization may be conductive or non-conductive. A metallization layer may also be formed by any of the printing processes described above. The metallization layer may be a continuous layer, or a layer wherein metallized portions and non-metallized portions form a pattern or other graphics or text. Patterns may be created during the deposition process, or the deposition may comprise deposition of a continuous layer, with removal of portions of the layer (e.g., via etching, laser, or physical or chemical removal) to form the pattern.

The various layers as discussed above (and any other layers) may be combined in any permutation or combination, in various orders to achieve desired optical effects. The potential presence of additional layers is depicted schematically in FIG. 6A, in which layers 50a and 50b may comprise any combination of layers or sublayers as described herein (e.g., antenna layer and graphics layer; graphics layer with adhesive or adhesion promotion layer, graphics layer with e-glass layer, etc.). In other embodiments, layer 50 may be a single ply layer (such as is illustrated in FIG. 6B). In other embodiments, one or both of sublayers 50a and 50b in FIG. 6A may each represent more than one sublayer (e.g., where sublayer 50b comprises an e-glass layer that itself comprises a base layer and an oxide layer).

Although described herein largely in connection with processes using “molten” plastic or polymer (typically understood to refer to plastic or polymer materials liquified by heating above a solid/liquid transition temperature, which “cures” to a solid state by cooling), the invention is not limited thereto. The invention described herein may be practiced using any sufficiently flowable plastic or polymer that is later cured to a solid state by any method of curing. For example, without limitation thereto, uncured radiation curable plastic or polymer (i.e., a photopolymer) may be used as the flowable material, and the curing step may comprise exposing the uncured plastic or polymer to actinic radiation. For example, polymers curable by radiation in the ultraviolet (UV) spectrum are well known. Similarly, polymers curable by exposure to moisture or a selected gas, such as humidity and/or oxygen in ambient air, are also well known. The invention is not limited to any particular type of polymer subject to any particular type of curing, and in addition to polymers that cure thermally by cooling or by exposure to radiation, moisture, or oxygen, may include use of thermally cured polymers that require additional heat to cure the polymer, chemical / additive curable polymers, such an a epoxy that cures when mixed with a hardening agent or catalyst (e.g. where the multiple parts of the epoxy system are mixed just before injection), or polymers that cure by drying (e.g. by solvent or water evaporation).

Likewise, although discussed herein primarily with respect to use of a metal substrate layer, the materials of construction of the substrate layer are not limited to any particular materials of construction or combinations thereof. Suitable substrate materials include plastic, fiber reinforced polymer (FRP), carbon fiber, metal, ceramic, glass, animal- or plant-derived materials, and combinations of any of the foregoing, without limitation. Exemplary plant-derived material (i.e. cellulose) substrates include but are not limited to natural wood, such as one or more natural layers of hardwood or softwood, or engineered wood substrates, such as plywood, compressed wood or other cellulose products (e.g. comprising particles, sawdust, fibers, and/or flakes combined with resin, including but not limited to particleboard or fiberboard). Cellulose substrates may include any type of plant-sourced fibers. Likewise, animal-derived materials (natural or imitation), may include any leather or skin known in the art.

As used herein, the term “plastic” refers to refers to any synthetic or semisynthetic material composed primarily of polymers (or monomers) having suitable plasticity that allows the material to be molded, extruded, or pressed into a diverse range of solid forms. The term “polymer” refers to any natural and synthetic material comprising polymerized monomers that have suitable properties for the uses as described herein.

The injection molded label process as described herein may also utilize metal injection molding (MIM) and MIM-like processes featuring amorphous metal alloys that maintain an amorphous atomic structure in a solid state, also known as bulk metallic glass, such as but not limited to materials branded as Liquid Metal®, made by Liquidmetal Technologies, Inc. of Lake Forest, California, USA. Suitable processes may include forming the amorphous metal component by injection, adding the label, and injecting around the label and metal component with plastic, in contemporaneous or sequential steps. As is understood by those of skill in the art, amorphous metals are non-crystalline in nature wherein the metal lacks an organized grain structure at the atomic level.

Although the embodiments as described herein refer to substrate 13 having a hole 12 that is a through-hole, in embodiments, hole 12 may be in the form of a blind pocket (with an opening to only one surface of the card), or hole 12 may define an opening to a first (e.g. top) surface having a first area and an opening to the second (e.g. bottom) surface that is smaller than the first area. Such first and second areas may form a ledge or floor on which to rest the IC chip, with a continuous floor across the bottom of a blind pocket and a ledge featuring an opening in the floor that is smaller than the opening that defines the top of the pocket. The blind pocket or ledge so formed may have one or more wires or standoffs embedded therein that extend from the inside of the pocket to the adjacent surface of the substrate through the floor or ledge of the pocket (or may comprise additional perforations for receiving such wires or standoffs), to permit connection of the IC chip (e.g. to La/Lb pads known in the art) to another component, circuit, or portion thereof (e.g. booster antenna, power source, biometric sensor, etc.) located in a different layer of the completed or semi-completed card. Hole 12 may be sized to receive the largest periphery of the IC chip (i.e. in a payment module, the periphery that is visible on a finished dual interface card and available for connecting to a contact-type point of sale device), or hole 12 may have a periphery that is smaller than the largest periphery and sized only to fit a smaller peripheral portion of the payment module (i.e. the epoxy blob/lower level of an IC chip module), wherein the larger peripheral portion of the IC chip is disposed above the substrate layer in the finished card).

FIG. 6C schematically illustrates a typical cross-sectional view of an IC chip 102 having a top portion 104 with a larger periphery than the bottom portion 106, and the corresponding dimensions of a substrate 110 with a hole 112 (depicted as a blind pocket) in which conductive members (e.g. wires or standoffs or posts) 114, 116 extend through the floor of the pocket 112. The other layers of the blank are not shown, and the IC chip and substrate are not to scale. However, it should be understood that in a typical arrangement top surface of 104 is flush with a top surface of the completed card, and the bottom surface of portion 106 of the IC chip rests on the bottom of pocket 112 so that pads (not shown) on the bottom of portion 106 align with and make contact with conductive members 114 and 116. Conductive members 114 and 116 may be connected to other components or circuits embodied in the substrate (not shown), such as via traces (not shown) disposed on the surface of the substrate. In other configurations (not shown), opening 112 may be a through-hole that allows the IC chip to contact corresponding conductive members on a layer disposed below the substrate (not shown). In still other embodiments, opening 112 may have a first portion extending to a first depth have a periphery to receive top portion 104 of the IC chip, and a second portion having a second depth beneath the first depth, having a periphery sized to receive portion 106 of the IC chip.

In embodiments, it may be desired for the card to have at least one tactile (tactilely perceptible) surface features, such as a textured pattern or design on one or both surfaces or in a portion thereof, defined by one or more embossed ridges (raised relative to the rest of the planar surface of the card) 65, debossed valleys (indented relative to the rest of the planar surface) 67, or a combination thereof. Because the outer layers of the card are formed in contact with the surface of the mold, component 70 of the mold that forms the surface of the card may have the corresponding inverse embossing and debossing surface elements (e.g. embossing valleys 75 in the mold component 70 that forms embossed ridges 65 on the card surface, or debossing ridges 77 in the mold surface that form debossed valleys 67 in the card surface). Creation of the at least one tactile feature may include the use of any tactile-in-mold process, method, or system known in the art. Tactile effects may also be created by printing or otherwise applying a surface effect to the graphics layer (e.g. label) before insertion into the mold, wherein the plastic formed over that the label embodying the surface effect forms corresponding tactile surface features. Tactile surface features may also include any degree of surface roughness or unevenness relative to a comparatively smooth surface. Methods for achieving suitable surface features (e.g., a glossy finish, a matte finish, a roughened surface feature), including visual surface features that may be only moderately perceived by touch of an ordinary customer, are well known in the art. Surface features may be aesthetic or functional. For example, a roughened surface may be provided on a designated functional portion of the card intended to receive a user signature.

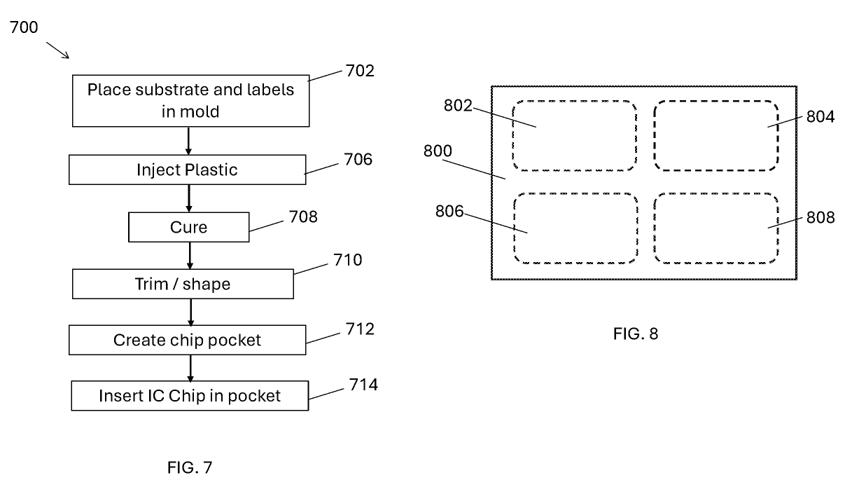

Although depicted herein as a single card in most of the figures, it should be understood that in embodiments, the process may comprise using sheets for each layer as described, wherein each multi-layer sheet is configured to later be cut, punched, stamped, or otherwise processed into a plurality of separate transaction card blank intermediates (e.g. 2, 4, 6, 8, 10, 12, 14, 16, etc., without limitation). Thus, the term “label” as used herein may have a size and shape corresponding to a single card or of a sheet configured to be cut into a plurality of cards. Thus, for example, as depicted in FIG. 8, sheet 800 may be formed by any of the processes as described herein, from which card blank intermediates 802, 804, 806 and 808 are later separated.

The exemplary embodiment and figures as discussed herein refer to a “card,” which is generally interpreted to refer to a CR80 smartcard known to consumers as a standard credit/debit card. As is known in the art, CR80 is the global, industry-standard size for smart cards, credit cards, and ID badges, measuring 3.375” x 2.125” (85.6 x 54 mm) with a 30 mil (0.766 mm thickness), often referred to as ISO/IEC 7810 ID-1 format. However, the invention is not limited to any particular size and shape of card, nor to any specific form factor. Embodiments of the invention may include fabrication of a token of any size and shape having a chip configured to provide at least contactless payment or other transaction functionality. It should be understood that dual interface technology may also be provided using any token having a chip positioned to fit into a suitable contact-based point of sale (POS) system, which system / token combination may utilize geometries different than those commonly used today. Likewise, while depicted in a traditional dual interface format smartcard, with a chip, having both contact-based and contactless functionality, and positioned in a traditional location where it interfaces with traditional POS readers, card and other form factor embodiments are not limited to the use of dual interface chips, and may in some embodiments have solely contactless functionality.

For example, a contactless-only card may feature an opening (through-hole) in a central region (not necessarily exactly centered, but anywhere inset from the perimeter) of the (e.g. metal) core, sized to receive a contactless inlay with contactless only chip in the thru hole, with or without a slit / discontinuity from the hole to the core periphery. Both sides are then subjected to the in-mold processing steps as described herein, with a “label” on one or both sides of core, as described herein. Of course, such a configuration is not limited to a “card” construction but rather is applicable to any form factor token.

Although described herein in exemplary embodiments with a hole and/or slit pre-formed in the core (and label layers) prior to performing the remaining processing steps, it should be understood that in other embodiments, the hole and/or slit may be formed after the (e.g. metal) core and label layers have been embedded in the injection molded surround, such as by milling into the blank in accordance with processes known in the art.

As used herein, the term “hole” may refer to through-holes, blind pockets, and stepped openings, without limitation, unless expressly modified by terms or description indicating such limitation. The term “blank” is used herein to refer to the “card blank intermediate” (the carrier + overmolded intermediate) to distinguish from “blank smart cards” (cards ready for personalization). Of course, tokens in non-card form may similarly have an intermediate form coming out of the mold and a non-personalized form that is otherwise finished and ready for personalization.

Notably, while described in connection with certain embodiments having certain features, embodiments of the invention may include any permutation or combination of the features as described herein (except for mutually exclusive features that will be clearly understood by those of skill in the art), while other embodiments may include fewer than all features as described herein.

Although the invention is illustrated and described herein with reference to specific embodiments, the invention is not intended to be limited to the details shown. Rather, various modifications may be made in the details within the scope and range of equivalents of the claims and without departing from the invention.

### ASPECTS OF THE INVENTION

Aspect 1: A process for making a transaction card, the process comprising the steps of:

(a) placing a substrate layer and at least one graphics layer in a mold, the substrate layer having opposite surfaces and a periphery;

(b) introducing a flowable plastic material into the mold, wherein the plastic material cures to form a molded plastic material that bonds with and overlays the at least one graphics layer and connects the at least one graphics layer to the substrate layer.

Aspect 2: The process of Aspect 1, wherein the substrate layer comprises metal.

Aspect 3: The process of Aspect 1 or Aspect 2, wherein the substrate further comprises a hole, and, optionally, a discontinuity from the hole to the periphery, and the hole has a first set of dimensions and a predetermined integrated circuit (IC) chip to be embedded in the transaction card has a second set of dimensions smaller than the first set of dimensions, the process further comprising disposing an insert into the hole, the insert dimensioned to bridge the second set of dimensions to the first set of dimensions.

Aspect 4: The process of Aspect 3, comprising disposing the insert into the hole prior to performing step (b).

Aspect 5: The process of Aspect 4, wherein disposing the insert into the hole comprises a force fit of the insert in the hole, thermally setting the insert in the hole, or welding the insert into the hole.

Aspect 6. The process of any one of the Aspects 3-5, wherein the insert comprises a same material as the substrate layer.

Aspect 7. The process of any one of the foregoing Aspects, wherein the substrate layer further comprises a plurality of perforations extending between the opposite surfaces of the metal layer, wherein the molten flowable plastic material fills the perforations during step (b).

Aspect 8. The process of any one of the foregoing Aspects, wherein the at least one graphics layer has an outer-facing surface and an inner-facing surface, and the plastic material extends between the inner-facing surface and the substrate layer and over the outer-facing surface to define an outer surface of the transaction card.

Aspect 9: The process of any one of the foregoing Aspects, wherein the transaction card comprises a front graphics layer and a back graphics layer, wherein the front graphics layer is connected to a first surface of the substrate layer by a front portion of the molded plastic material and the back graphics layer is connected to a second surface of the substrate layer by a back portion of the molded plastic material during the molding step.

Aspect 10: The process of any one of the foregoing Aspects, further comprising the step of:

(c) trimming away one or more portions of one or more of the substrate layer, the at least one graphics layer, and the plastic material to define a finished transaction card blank intermediate having a desired periphery; and

optionally, prior to step (c), imposing a curing step prior to the trimming step, optionally wherein the flowable plastic comprises a molten plastic and the curing step comprises a cooling step, optionally wherein the cooling step has a duration sufficient to offset any differences in thermal expansion among the substrate layer, the at least one graphics layer, and the flowable plastic material.

Aspect 11: The process of Aspect 10, wherein during performance of steps (a) and (b), the substrate layer has a plurality of tabs, each tab featuring a carrying hole, and step (c) includes trimming away the plurality of tabs.

Aspect 12: The process of Aspect 10 or Aspect 11, further comprising the step of:

(d) forming a designated pocket aligned with the hole in the substrate layer, the designated pocket extending from a top surface of the at least one graphics layer, through a portion of the plastic layer, and within the hole; and

(e) securing a payment module into the designated pocket.

Aspect 13: The process of Aspect 12, wherein step (d) is performed by a portion of the mold during step (b), wherein the portion of the mold has predetermined dimensions corresponding to the designated pocket and extends from the at least one graphics layer to a desired depth within the hole.

Aspect 14: The process of Aspect 12, wherein step (d) is performed by a material removal step after at least step (b) has been completed.

Aspect 15: The process of any one of the foregoing Aspects, wherein the substrate layer or the at least one graphics layer has an adhesion promoting layer, an adhesive, or a combination thereof on at least one surface thereof.

Aspect 16: The process of any one of the foregoing Aspects, wherein the molding step is performed on an in-mold labeling (IML) machine and the at least one graphics layer is provided to the IML machine as a label.

Aspect 17: The process of Aspect 16, wherein the label is supplied to the machine on a roll.

Aspects 18: The process of Aspect 16 or Aspect 17, wherein the label comprises a plurality of layers.

Aspect 19: The process of Aspect 18, wherein the label comprises a transparent layer and at least one layer of printed graphics.

Aspect 20: The process of Aspect 19, wherein the label comprises one or more of: an antenna layer or a magnetic strip.

Aspect 21: The process of any one of Aspects 16-20, wherein the label is supplied to the machine as a sheet.

Aspect 22: The process of Aspect 21, wherein the sheet has a size and shape corresponding to a plurality of transaction cards, and the substrate and the molded plastic material that connects the sheet to the substrate layer has a shape coextensive with the sheet, and the process further comprises the step of:

(d) processing the connected sheet, substrate layer, and molded plastic material into a plurality of card blank intermediates each having a periphery corresponding to a single transaction card.

Aspect 23: The process of any one of the foregoing Aspects, wherein the plastic material defines an outer surface of the transaction card having at least one tactile feature.

Aspect 24: The process of Aspect 23, wherein the tactile feature comprises at least one embossed or debossed feature.

Aspect 25: The process of Aspect 24, further comprising creating the at least one embossed or debossed feature using a corresponding embossing or debossing surface element of the mold.

Aspect 26: The process of Aspect 23, further comprising creating the tactile feature by providing the label with a surface effect that promotes the tactile feature on the outer surface of the transaction card.

Aspect 27: The process of any one of the foregoing Aspect, wherein the flowable plastic material comprises a molten polymer material.

Aspect 28: The process of any one of Aspect 1-26, wherein the flowable plastic material comprises a polymer curable by exposure to a source of actinic radiation, wherein the process further comprises exposing the curable polymer to actinic radiation.

Aspect 29: The process of Aspect 1, wherein the substrate layer comprises a material selected from the group consisting of: plastic, fiber reinforced polymer (FRP), carbon fiber, metal, ceramic, glass, animal- or plant-derived materials, and combinations thereof.

Aspect 30: The process of any one of the foregoing Aspects, wherein the substrate comprises a through-hole.

Aspect 31: The process of any one of the foregoing Aspects comprising injecting a first portion of the flowable plastic from a first side of the substrate and a second portion of the flowable plastic from a second side of the substrate.

Aspect 32: The process of Aspect 31, wherein the first portion and the second portion form a connection with one another.

Aspect 33: The process of Aspect 31, wherein the first portion and the second portion do not form a connection to one another.

Aspect 34: A smart card, blank smart card, or blank smart card intermediate comprising a product of the process of any one of Aspects 1-33a.

Aspect 35: A smart card, blank smart card, or smart card intermediate comprising:

a substrate layer having opposite surfaces and a periphery;

at least one graphics layer having an outer-facing surface and an inner-facing surface; and

a molded plastic material bonded to the at least one graphics layer and having a first portion extending over the outer-facing surface of the at least one graphics layer, a second portion extending between the inner-facing surface at least one graphics layer and one of the opposite surfaces of the substrate metal layer, and one or more interconnecting portions extending into the substrate layer.

Aspect 36: The smart card, blank smart card, or smart card intermediate of claim 35, wherein the substrate layer further comprises a first hole, and optionally, a discontinuity from the first hole to the periphery, the smart card, blank smart card, or smart card intermediate further comprising:

an integrated circuit (IC) chip mounted in a designated pocket extending from the at least one graphics layer, through the molded plastic layer, and within at least a portion of the first hole in the substrate layer.

Aspect 37: The smart card of Aspect 36, wherein the first hole in the substrate layer has a first set of dimensions and the IC chip has a second set of dimensions smaller than the first set of dimensions, the card further comprising an insert disposed in the first hole bridging the second set of dimensions to the first set of dimensions.

Aspect 38: The smart card, blank smart card, or smart card intermediate of any one of Aspects 35 - 37, wherein the substrate layer further comprises a plurality of perforations extending between the opposite surfaces of the substrate layer, and the molded plastic material extends through the perforations.

Aspect 39: The smart card, blank smart card, or smart card intermediate of any one of Aspects 35-38, wherein the card comprises a front graphics layer and a back graphics layer, the front graphics layer bonded over a first surface of the substrate layer by the second portion of the molded plastic layer, the back graphics layer bonded over a second surface of the substrate layer by a third portion of the molded plastic material, the first portion of the molded plastic material defining a front surface of the card, and a fourth portion of the molded plastic material defining a back surface of the card.

Aspect 40: The smart card, blank smart card, or smart card intermediate of Aspect 39, wherein the molded plastic material surrounds the front graphics layer, the back graphics layer, and the substrate metal layer.

Aspect 41: The smart card, blank smart card, or smart card intermediate of Aspect 40, wherein the fourth portion of the molded plastic layer defines a discrete layer unconnected to any other portion, and the second and third portions of the molded plastic material are connected to one another by the one or more interconnecting portions of the molded plastic material, wherein the first hole is a through-hole and one or more interconnecting portions extend through one or more of the first hole and the optional discontinuity.

Aspect 42: The smart card, blank smart card, or smart card intermediate of Aspect 41, wherein the substrate layer comprises a plurality of perforations extending between opposite surfaces of the substrate layer and the one or more interconnecting portions of the molded plastic material further extend through the plurality of perforations.

Aspect 43: The smart card, blank smart card, or smart card intermediate of Aspect 41, wherein the one or more interconnecting portions connect the first portion, the second portion, and the third portion of the molded plastic material via the first hole in the substrate layer and a through-hole in the front graphics layer aligned with the first hole in the substrate layer to define a molded pocket.

Aspect 44: The smart card, blank smart card, or smart card intermediate of Aspect 39, wherein each of the first and fourth portions of the molded plastic material each defines a discrete layer unconnected to any other portion of the molded plastic material.

Aspect 45: The smart card, blank smart card, or smart card intermediate of Aspect 44, wherein the first portion of the molded plastic material has a milled pocket extending from a top surface of the first portion of the molded plastic material, through the front graphics layer, and through at least a part of an interconnecting portion between the second portion and the third portion of the of the molded plastic material that extends into or through the first hole in the substrate layer.

Aspect 46: The smart card, blank smart card, or smart card intermediate of claim 39, wherein the substrate layer extends to a periphery of the card in a plurality of substrate edge locations, and wherein the molded plastic material interconnects the first, second, third, and fourth portions of the molded plastic material in regions of the card periphery disposed between the plurality of substrate edge locations.

Aspect 47: The smart card, blank smart card, or smart card intermediate of any one of Aspects 35-46, further comprising one or more of an antenna layer or a magnetic strip.

Aspect 48: The smart card, blank smart card, or smart card intermediate of Aspect 35, further comprising a magnetic strip disposed on the outer-facing surface of the at least one graphics layer.

Aspect 49: The smart card, blank smart card, or smart card intermediate of any one of Aspects 35-48, further comprising an adhesive, an adhesion promoting layer, or adhesive bonds formed between the molded plastic material and the substrate layer or the at least one graphics layer on one or both of the opposite surfaces of the substrate layer.

Aspect 50: The smart card, blank smart card, or smart card intermediate of any one of Aspects 35-49, wherein the substrate layer comprises metal.

Aspect 51: The smart card, blank smart card, or smart card intermediate of any one of Aspects 35-50, further comprising at least tactile feature on an outer surface of the card.

Aspect 52: The smart card, blank smart card, or smart card intermediate of Aspect 36, wherein the IC chip has a first set of dimensions that define a first periphery and a second set of dimensions that define a second periphery smaller than the first periphery, the second periphery defining a boundary of a bottom area of the IC chip, wherein the at least one hole in the substrate comprises a pocket with a floor having a plurality of conductive members that extend through the floor and are positioned to align with corresponding contact pads located on the bottom area of the IC chip.

Aspect 53: The smart card, blank smart card, or smart card intermediate of Aspect 36, wherein the IC chip has a first set of dimensions that define a first periphery and a second set of dimensions that define a second periphery smaller than the first periphery, the second periphery defining a boundary of a bottom area of the IC chip, wherein the at least one hole in the substrate comprises a through-hole sized to receive the second periphery of the IC chip.

Aspect 54: The smart card, blank smart card, or smart card intermediate of Aspect 36, wherein the IC chip has a first set of dimensions that define a first periphery and a second set of dimensions that define a second periphery smaller than the first periphery, the second periphery defining a boundary of a bottom area of the IC chip, wherein the at least one hole in the substrate comprises a first portion extending for a first depth sized to receive the first periphery of the IC chip and a second portion extending for a second depth sized to receive the second periphery of the IC chip.

Aspect 55: The smart card, blank smart card, or smart card intermediate of any one of the foregoing Aspects 34-54, comprising at least one layer selected from the group consisting of:

a printed layer;

an e-glass layer;

a metallized layer;

an epoxy layer; and

combinations of any of the foregoing.

Aspect 56: The smart card, blank smart card, or smart card intermediate of any one of the foregoing claims, wherein the molded plastic material comprises a material selected from the group consisting of: a photopolymer curable by exposure to actinic radiation, a polymers curable by exposure to moisture or a selected gas, a thermally cured polymer cured by heating, or a chemical / additive curable polymer; and combinations of any of the foregoing.

Aspect 57: The smart card, blank smart card, or smart card intermediate of any one of the foregoing claims, wherein the substrate comprises a material of construction selected from the group consisting of: plastic, fiber reinforced polymer (FRP), carbon fiber, metal, ceramic, glass, animal- or plant-derived materials, and combinations of any of the foregoing.

Aspect 58: The smart card, blank smart card, or smart card intermediate of Aspect 56, wherein the substrate comprises an amorphous metal alloy.

Aspect 59: A smart card, blank smart card, or smart card intermediate comprising:

a metal substrate layer having a top surface, a bottom surface, a periphery, at least one hole, and a discontinuity extending from the top surface to the bottom surface and from the at least one hole to the periphery;

a top graphics layer having an outer-facing surface and an inner-facing surface;

a bottom graphics layer having an outer-facing surface and an inner-facing surface; and

a molded plastic material bonded to the top graphics layer, the bottom graphics layer, and the metal substrate layer, the molded plastic material defining a first portion extending over the outer-facing surface of the top graphics layer, a second portion extending between the inner-facing surface of the top graphics layer the top surface of the metal layer, a third portion extending between the inner-facing surface of the bottom graphics layer and the bottom surface of the metal layer, a fourth portion extending over the outer-facing surface of the bottom graphics layer, and one or more interconnecting portions connecting the second portion to the third portion extending at least through the at least one through-hole and the discontinuity.

Aspect 60: The smart card, blank smart card, or smart card intermediate of Aspect 59, wherein the metal substrate layer further comprises a plurality of perforations, and the one or more interconnecting portions of the molded plastic material extend through the plurality of perforations to connect the second portion to the third portion.

Aspect 61: The smart card, blank smart card, or smart card intermediate of Aspect 59 or Aspect 60, further comprising a magnetic strip disposed on the outer-facing surface of the bottom graphics layer.

Aspect 62: The smart card, blank smart card, or smart card intermediate of any one of Aspects 59-61, further comprising at least one molded embossed or debossed feature on at least a portion of an outer surface of at least one of the first portion or fourth portion of the molded plastic material.

Aspect 63: The smart card, blank smart card, or smart card intermediate of any one of Aspects 59-62, wherein the one or more interconnecting portions extends through at least the through hole to define a molded pocket.

Aspect 64: The smart card, blank smart card, or smart card intermediate of Aspect 63, further comprising an integrated circuit (IC) chip disposed in the molded pocket.

Aspect 65: The smart card, blank smart card, or smart card intermediate of Aspect 64, wherein nonconductive material extends between an outer periphery of the IC chip and an inner periphery of the hole in the metal substrate.

Aspect 66: The smart card, blank smart card, or smart card intermediate of Aspect 65, wherein the nonconductive material comprises the molded plastic material, an adhesive, or a combination thereof.

Aspect 67: The smart card, blank smart card, or smart card intermediate of any one of Aspects 59-66, further having an outer surface comprising at least one tactile feature.

Aspect 68: The smart card, blank smart card, or smart card intermediate of Aspect 67, wherein the tactile feature corresponds to a surface effect on the outer-facing surface of one of the top graphics layer or the bottom graphics layer that promotes the tactile feature on the outer surface.

What is claimed:

1. A process for making a transaction card, the process comprising the steps of:
(a) placing a substrate layer and at least one graphics layer in a mold, the substrate layer having opposite surfaces, a periphery, and, optionally, a discontinuity from the hole to the periphery;
(b) introducing a flowable plastic material into the mold, wherein the plastic material cures to form a molded plastic material that bonds with and overlays the at least one graphics layer and connects the at least one graphics layer to the substrate layer.

2. The process of claim 1, wherein the substrate layer comprises metal.

3. The process of claim 2, wherein the substrate layer comprises a hole, and optionally, a discontinuity from the hole to the periphery, in which the hole has a first set of dimensions and a predetermined integrated circuit (IC) chip to be embedded in the transaction card has a second set of dimensions smaller than the first set of dimensions, the process further comprising disposing an insert into the hole, the insert dimensioned to bridge the second set of dimensions to the first set of dimensions.

4. The process of claim 3, comprising disposing the insert into the hole prior to performing step (b).

5. The process of claim 4, wherein disposing the insert into the hole comprises a force fit of the insert in the hole, thermally setting the insert in the hole, or welding the insert into the hole.

6. The process of claim 3, wherein the insert comprises a same material as the substrate layer.

7. The process of claim 1, wherein the substrate layer further comprises a plurality of perforations extending between the opposite surfaces of the metal layer, wherein the flowable plastic material fills the perforations during step (b).

8. The process of claim 1, wherein the at least one graphics layer has an outer-facing surface and an inner-facing surface and the plastic material extends between the inner-facing surface and the substrate layer and over the outer-facing surface to define an outer surface of the transaction card.

9. The process of claim 1, wherein the transaction card comprises a front graphics layer and a back graphics layer, wherein the front graphics layer is connected to a first surface of the substrate layer by a front portion of the molded plastic material and the back graphics layer is connected to a second surface of the substrate layer by a back portion of the molded plastic material during the molding step.

10. The process of claim 1, further comprising the step of:
(c) trimming away one or more portions of one or more of the substrate layer, the at least one graphics layer, and the plastic material to define a finished transaction card blank intermediate having a desired periphery; and
optionally, prior to step (c), imposing a curing step prior to the trimming step, optionally wherein the flowable plastic comprises a molten plastic and the curing step comprises a cooling step, optionally wherein the cooling step has a duration sufficient to offset any differences in thermal expansion among the substrate layer, the at least one graphics layer, and the flowable plastic material.

11. The process of claim 10, wherein during performance of steps (a) and (b), the substrate layer has a plurality of tabs, each tab featuring a carrying hole, and step (c) includes trimming away the plurality of tabs.

12. The process of claim 10, wherein the substrate layer comprises a hole, further comprising the step of:
(d) forming a designated pocket aligned with the hole in the substrate layer, the designated pocket extending from a top surface of the at least one graphics layer, through a portion of the plastic layer, and within the hole; and
(e) securing a payment module into the designated pocket.

13. The process of claim 12, wherein step (d) is performed by a portion of the mold during step (b), wherein the portion of the mold has predetermined dimensions corresponding to the designated pocket and extends from the at least one graphics layer to a desired depth within the hole.

14. The process of claim 12, wherein step (d) is performed by a material removal step after at least step (b) has been completed.

15. The process of claim 1, wherein the substrate layer or the at least one graphics layer has an adhesion promoting layer, an adhesive, or a combination thereof on at least one surface thereof.

16. The process of claim 1, wherein the molding step is performed on an in-mold labeling (IML) machine and the at least one graphics layer is provided to the IML machine as a label.

17. The process of claim 16, wherein the label is supplied to the machine on a roll.

18. The process of claim 16, wherein the label comprises a plurality of layers.

19. The process of claim 18, wherein the label comprises a transparent layer and at least one layer of printed graphics.

20. The process of claim 19, wherein the label comprises one or more of: an antenna layer or a magnetic strip.

21. The process of claim 16, wherein the label is supplied to the machine as a sheet.

22. The process of claim 21, wherein the sheet has a size and shape corresponding to a plurality of transaction cards, and the substrate and the molded plastic material that connects the sheet to the substrate layer has a shape coextensive with the sheet, and the process further comprises the step of:
(d) processing the connected sheet, substrate layer, and molded plastic material into a plurality of card blank intermediates each having a periphery corresponding to a single transaction card.

23. The process of claim 1, wherein the plastic material defines an outer surface of the transaction card having at least one tactile feature.

24. The process of claim 23, wherein the tactile feature comprises at least one embossed or debossed feature.

25. The process of claim 24, further comprising creating the at least one embossed or debossed feature using a corresponding embossing or debossing surface element of the mold.

26. The process of claim 23, further comprising creating the tactile feature by providing the label with a surface effect that promotes the tactile feature on the outer surface of the transaction card.

27. The process of claim 1, wherein the flowable plastic material comprises a molten polymer material.

28. The process of claim 1, wherein the flowable plastic material comprises a polymer curable by exposure to a source of actinic radiation, wherein the process further comprises exposing the curable polymer to actinic radiation.

29. The process of claim 1, wherein the substrate layer comprises a material selected from the group consisting of: plastic, fiber reinforced polymer (FRP), carbon fiber, metal, ceramic, glass, animal- or plant-derived materials, and combinations thereof.

30. The process of claim 1, wherein the substrate has at least one through-hole.

31. The process of claim 1, comprising injecting a first portion of the flowable plastic from a first side of the substrate and a second portion of the flowable plastic from a second side of the substrate.

32. The process of claim 31, wherein the first portion and the second portion form a connection with one another.

33. The process of claim 31, wherein the first portion and the second portion do not form a connection to one another.

34. A smart card, blank smart card, or blank smart card intermediate comprising a product of the process of claim 1.

35. The smart card, blank smart card, or smart card intermediate of claim 34, comprising:
the substrate layer having the opposite surfaces and the periphery;
the at least one graphics layer having an outer-facing surface and an inner-facing surface; and
the molded plastic material bonded to the at least one graphics layer and having a first portion extending over the outer-facing surface of the at least one graphics layer, a second portion extending between the inner-facing surface at least one graphics layer and one of the opposite surfaces of the substrate layer, and one or more interconnecting portions extending into the substrate layer.

36. The smart card, blank smart card, or smart card intermediate of claim 35, wherein the substrate layer is metal and has a top surface, a bottom surface, at least one hole, and a discontinuity extending from the top surface to the bottom surface and from the at least one hole to the periphery;
a top graphics layer and a bottom graphics layer each having a respective outer-facing surface and an inner-facing surface;
wherein the molded plastic material is bonded to the top graphics layer, the bottom graphics layer, and the metal substrate layer, the molded plastic material first portion extends over the outer-facing surface of the top graphics layer, the second portion extends between the inner-facing surface of the top graphics layer and the top surface of the metal layer, a third portion extends between the inner-facing surface of the bottom graphics layer and the bottom surface of the metal layer, a fourth portion extends over the outer-facing surface of the bottom graphics layer, and the one or more interconnecting portions connects the second portion to the third portion extending at least through the at least one hole and the discontinuity.

37. A smart card, blank smart card, or smart card intermediate comprising:
a substrate layer having opposite surfaces, a periphery;
at least one graphics layer having an outer-facing surface and an inner-facing surface; and
a molded plastic material bonded to the at least one graphics layer and having a first portion extending over the outer-facing surface of the at least one graphics layer, a second portion extending between the inner-facing surface at least one graphics layer and one of the opposite surfaces of the substrate layer, and one or more interconnecting portions extending into the substrate layer.

38. A smart card, blank smart card, or smart card intermediate comprising:
a metal substrate layer having a top surface, a bottom surface, a periphery, at least one hole, and a discontinuity extending from the top surface to the bottom surface and from the at least one hole to the periphery;
a top graphics layer having an outer-facing surface and an inner-facing surface;
a bottom graphics layer having an outer-facing surface and an inner-facing surface; and
a molded plastic material bonded to the top graphics layer, the bottom graphics layer, and the metal substrate layer, the molded plastic material defining a first portion extending over the outer-facing surface of the top graphics layer, a second portion extending between the inner-facing surface of the top graphics layer the top surface of the metal layer, a third portion extending between the inner-facing surface of the bottom graphics layer and the bottom surface of the metal layer, a fourth portion extending over the outer-facing surface of the bottom graphics layer, and one or more interconnecting portions connecting the second portion to the third portion extending at least through the at least one hole and the discontinuity.
